(19) United States
(12) Patent Application Publication
(10) Pub. No.: US 2005/0239543 A1
(43) Pub. Date: Oct. 27, 2005

(54) Method, apparatus, and program product for accessing player accounts in a gaming system

(76) Inventors: Joseph R. Enzminger, Austin, TX (US); Clifton Lind, Austin, TX (US); Jefferson C. Lind, Austin, TX (US)

Correspondence Address: Russell D. Culbertson;Shaffer & Culbertson, L.L.P., Suite 420, 1114 Lost Creek Blvd., Austin, TX, 78746, US

(21) Appl. No.: 10/832,784

(22) Filed: Apr. 27, 2004

(51) Int. Cl. A63F 13/00

(52) U.S. Cl. 463/29

(57) ABSTRACT

A gaming system method includes first reading external identifying information for a player from an external identification device carried by the player and then associating the external identifying information with a player account in a gaming system. The method further includes reading the external identifying information for the player from a player station device included the gaming system, and then accessing the player account using that external identifying information read from the player station device.

### TECHNICAL FIELD OF THE INVENTION

This invention relates to gaming systems. More particularly, the invention relates to the use of an external identification device to allow a player to access a player account in a gaming system.

### BACKGROUND OF THE INVENTION

Gaming systems commonly employ player tracking systems and/or player accounting systems in which a player uses some sort of identification device in order to performing various functions in the gaming system. For example, in cashless gaming systems a player may be issued a player card that includes an encoded account identifier that is associated with a player account. Such a cashless gaming system is disclosed in U.S. patent publication number 2002-0132666 A1 published Sep. 19, 2002 and entitled “Distributed Account Based Gaming System.” The entire content of this published application is incorporated herein by this reference. In this illustrative cashless gaming system, a player may be issued a player card having a player account identifier encoded on the card. The player may be required to have the encoded account identifier read from a card reading device at a player station in order to participate in games offered through the player station. In this example system, a player may also be required to have the account identifier read from their player card at a cashier terminal in order to withdraw cash from their account.

Player cards are also used, for example, in player club systems in which a player's activities are tracked through a player club account associated with the player. In these player club systems, the player may be issued a player club card that is encoded player club account identifier. The player may be required to have a player club account identifier read from the player club card at the beginning of any gaming session at a gaming machine or player station in the gaming system. Player club software executed by the gaming system then collects data regarding the player's activities. The player may obtain preferred treatment at the gaming facility by participating in such a player club system. Information gathered for the player's activities may also allow the gaming facility operator to better accommodate the player by making preferred types of games available at the gaming facility.

A problem with previous player card systems used in cashless gaming systems and/or player club systems is that the systems required a special card or other identification device issued by the gaming facility itself. Requiring a special identification device issued by the gaming facility required the player to carry yet another object with them in addition to all of the other identification devices and cards the player normally carries with them. Also, the issuance of player cards or other identification devices increased the cost of operating the gaming facility and thereby reduced profits from the facility.

### SUMMARY OF THE INVENTION

The present invention provides a method by which a player may use a card or other identification device that they already have in their possession as an identification device for use in accessing a player account in a gaming system. The present invention eliminates the requirement that the gaming facility itself issue a gaming system-specific player identification device, although preferred forms of the invention maintain that option for players who wish to use a special gaming system-specific identification device rather than a identification device the player may already have in their possession for other purposes.

An identification device a player already has in their possession independent of the gaming facility or gaming system will be referred to in this disclosure and the accompanying claims as an “external identification device.” The word “external” is intended in this definition to imply that the device is external to any device issued by the gaming facility to act as an account access or system login device. Examples of identification devices that represent external identification devices within the scope of this definition include a driver's license, other identification devices issued by governmental authorities such as military identification cards, identification devices issued by financial institutions such as credit cards or ATM cards, and security cards issued outside of the gaming facility or system. In any case, the external identification device will be encoded in some fashion with identifying information that is generally unique to the card owner. For example, the identifying information on an external identification device according to the invention may be encoded on a magnetic stripe or other magnetic medium on the card or device, stored in an integrated circuit chip included in the device, or encoded in a bar-code or other optically read structure on the device.

A gaming system embodying the principles of the invention includes an account assignment station, an account controller, and at least one player interface. The account assignment station and the player interface both include an external identification device reader that is adapted to read external identifying information for a player from an external identification device carried by the player. The account controller is operatively connected to the account assignment station to receive the external identifying information for the player read from the first external identification device reader. The account controller associates a player account for the player with the external identifying information for the player and stores this association. The player interface may be associated with a player station or other device in the gaming system and is also operatively connected to the account controller for communicating to the account controller the external identifying information read by the external identification device reader associated with the player interface. This identifying information communicated to the account controller from the player interface facilitates access to the player account for various purposes associated with the gaming system.

A method according to the invention includes first reading external identifying information for player from an external identification device and then associating the external identifying information with a player account in a gaming system. The method further includes reading the external identifying information for the player from a player interface device included the gaming system, and then accessing the player account using the external identifying information read at the player interface device.

The present invention also encompasses a program product stored on a computer readable medium. A program product according to the invention includes identifier association program code and account access program code. The identifier association program code receives external identifying information for a player from an external identification device and associates that external identifying information with a player account in a gaming system. The account access program code receives the external identifying information for the player from the player interface at a player station or other system device and accesses the player account using the external identifying information.

These and other advantages and features of the invention will be apparent from the following description of preferred embodiments, considered along with the accompanying drawings.

### BRIEF DESCRIPTION OF THE DRAWINGS

FIG. 1 is a diagrammatic representation of a gaming system embodying the principles of the present invention.

FIG. 2 is a diagrammatic representation of a processing system that may be employed for the central system and local area systems shown in FIG. 1.

FIG. 3 is a diagrammatic representation of a player station that may be used in a gaming system embodying the principles of the invention.

FIG. 4 is a diagrammatic representation of a account assignment/point-of-sale station that may be used in a gaming system embodying the principles of the invention.

FIG. 5 is a block diagram illustrating the method steps employed in a method embodying the principles of the invention.

FIG. 6 is a representation of an arrangement for associating an external identifier with a player account according to one form of the present invention.

FIG. 7 is a representation of an arrangement for associating an external identifier with a player account according to an alternate preferred form of the present invention.

### DESCRIPTION OF PREFERRED EMBODIMENTS

The claims at the end of this application set out novel features which the Applicants believe are characteristic of the invention. The various advantages and features of the invention together with preferred modes of use of the invention will best be understood by reference to the following description of illustrative embodiments read in conjunction with the drawings introduced above.

The present invention may be used with substantially any gaming system in which data or information regarding a player is stored in a manner in which the data or some portion of it may be accessed as the player participates in the gaming system. In particular, the invention may be used in gaming systems such as central determinant lottery-type gaming system, networked bingo gaming systems, gaming systems including stand alone gaming machines such as reel-type machines, video poker machines, and other card game machines. The invention may also be employed in casinos offering live card games or other live games, provided that the casinos use electronic player accounts associated with the various players. The figures illustrate one particular arrangement of elements which make up a gaming system in which the invention may be used. It will be appreciated, however, that the illustrated gaming system is shown only for purposes of example and is not intended to limit the scope of the invention as set forth in the following claims.

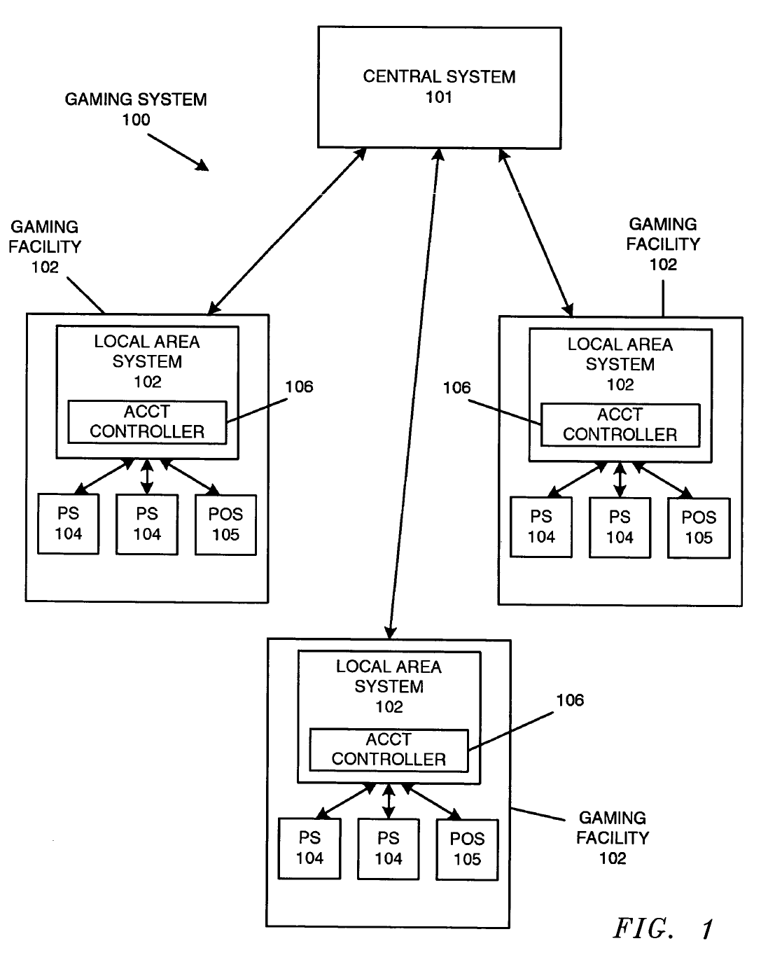

Referring to FIG. 1, a gaming system 100 in which the present invention may be employed includes a central system 101 in communication with a number of different gaming facilities 102. Each gaming facility 102 includes a local area system 103, one or more player stations 104 and one or more point-of-sale (POS) stations. This particular gaming system configuration could be used for a networked bingo gaming system or a central determinant lottery-type gaming system, for example, or some other gaming system that maintained control or records for several gaming facilitates at a central component such as central gaming system 101.

A gaming system embodying the present invention includes an account assignment station, an account controller 106, and at least one player interface. For the purpose of initial discussion, it will be assumed that an account assignment station in the gaming system 100 shown in FIG. 1 is implemented through a respective POS station 105, thus these stations will be referred to as account assignment/POS stations. It will also be assumed for the purpose of initial discussion that a respective player interface is implemented through each respective player station 104. It is also indicated in FIG. 1 that a separate account controller 106 according to the present invention is included with each local area system 103. It will be appreciated, however, that the gaming system configuration shown in FIG. 1 could implement an account controller within the scope of the present invention at central system 101 or even at the individual player stations 104. As described further below, a player interface within the scope of the invention is preferably also included at a gaming system component such as an account assignment/POS station 105 in order to allow a player to access their account for cashing out. It is also possible within the scope of the present invention for an account assignment station to be implemented at a player station such as stations 104 in FIG. 1.

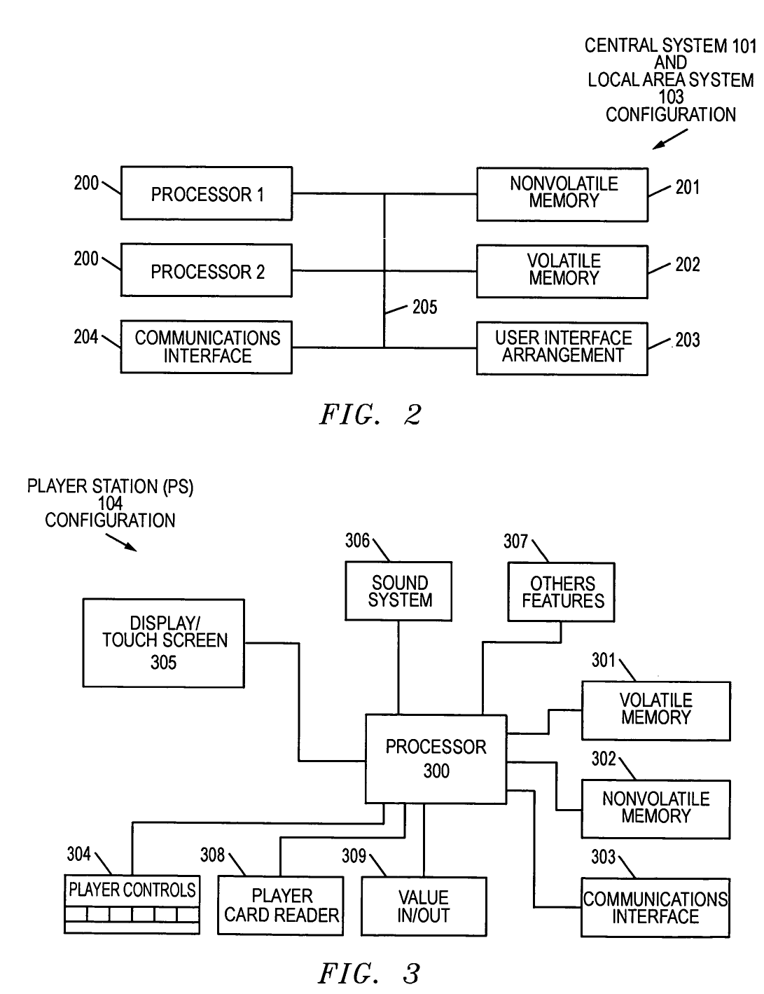

Depending upon the functions performed by central system 101 in gaming system 100, the central system may comprise a computer system such as the basic system shown in FIG. 2. The basic system may include one or more processors 200, nonvolatile memory 201, volatile memory 202, a user interface arrangement 203, and a communications interface 204, all connected to a system bus 205. It will be appreciated that user interface arrangement 203 may include a number of different devices such as a keyboard, a display, and a pointing device such as a mouse or trackball for example, although not shown in FIG. 2. Alternatively to the integrated user interface arrangement 203 shown in FIG. 2, a user interface for central system 101 may be provided through a separate computer (not shown) in communication with the central system. The functions performed by central system 101 in gaming system 100 will depend upon the nature of the gaming system. Since an understanding of the functions of central system 101 that are related to actually conducting games in gaming system 100 is not necessary for an understanding of the present invention, and could vary greatly from gaming system to gaming system, the functions of central system 101 will not be discussed here in detail. It will be appreciated that central system 101 may serve as a manufacturing and control center for manufacturing lottery type games where gaming system 100 comprises a central determinant lottery-type gaming system, or a center for grouping participants in bingo games and conducting bingo games where gaming system 100 comprises a networked bingo game system. An example of the former type of system is disclosed in U.S. patent publication No. 2002-0132666 A1 described and incorporated above, and an example of the latter type of gaming system is disclosed in U.S. patent application Ser. No. 10/456,721, entitled “Method, System, and Program Product for Conducting Multiple Concurrent Bingo-Type Games,” the entire content of which is hereby incorporated by reference. In yet other types of gaming systems 100, cental system 101 may simply provide a central repository for data collected in the course of providing games through the various player stations 104 shown in FIG. 1.

Each local area system 103 included in system 100 as shown in FIG. 1 may comprise a computer system having the same basic structure as shown in FIG. 2. That is, each local area system 103 may include one or more processors 200, nonvolatile memory 201, volatile memory 202, user interface arrangement 203, and communications interface 204 all connected to system bus 205. As with central system 101, the user interface for the respective local area system 102 may be provided through a separate computer that communicates with the local area system rather than the integrated user interface arrangement 203 shown in FIG. 2.

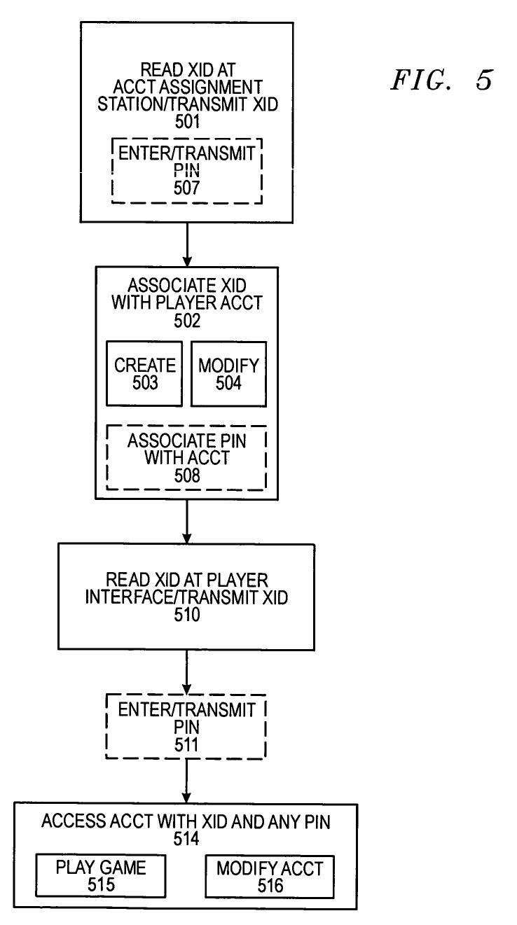

As with central system 101, the functions performed by each local area system 103 in gaming system 100 will depend upon the nature of the gaming system and the games offered on the gaming system. Where gaming system 100 comprises a central determinant lottery-type gaming system, each local area system 103 may serve as a local repository for electronic lottery tickets that are used to satisfy game play requests entered through the various player stations 104 at the particular gaming facility 102 in FIG. 1. Regardless of the other functions that may be performed at the local area systems 103 shown in FIG. 1, the illustrated embodiment of the invention implements an account controller 106 at each respective local area system 103. Each respective account controller 106 is operatively connected to communicate with the account assignment station/POS 105 of the respective gaming facility 102 shown in FIG. 1, and is also operatively connected for communications with each respective player station 104 at the respective gaming facility 102. The nature of the communications between each respective account controller 106 and the respective account assignment station/POS 105 and player stations 104 may vary significantly within the scope of the invention. That is, the invention is not limited any particular communications method or protocol between any of the components, including central system 101, local area systems 103 and player stations 104. For example, communications to and from controller 106 may be TCP/IP communications over an Ethernet connection, or serial communications over a suitable serial communications interface. In any case, the account controller 106 at a give gaming facility 102 in FIG. 1 receives external identifying information for the player from a local account assignment station/POS 105 and associates a player account for the player with information derived from the external identifying information for the player. Each account controller 106 also stores the association between the information derived from the external identifying information for the player and the player account for the player. Further detail on the operation of account controllers 106 will be described below with reference to FIG. 5 and the method of the present invention.

FIG. 3 shows an example of a player station 104 that may implement a player interface device according to the present invention. The illustrated player station 104 includes a processor 300, volatile memory 301, nonvolatile memory 302, and a communications interface 303. The volatile and nonvolatile memory store computer program code that may be executed by processor 300 to cause the processor to perform or direct the various functions provided by player station 104. Communications interface 303 allows communications between player station 104 and its respective local area system 103 and/or central system 101. Player station 104 shown in FIG. 3 also includes a special user interface arrangement to facilitate player participation in games offered through gaming system 100 shown in FIG. 1, and display results in an exciting and attractive format. This interface includes player controls 304, a display or touch screen display 305, a sound system 306, and perhaps other features 307 such as alarms or special displays or alerting devices. The player interface may allow the player to request game plays, perform functions during a game, obtain player account information, and enter a personal identification number (PIN) for example. Each player station 104 also includes an external identification device reader 308 that is adapted to read external identifier information from a suitable external identification device such as a card carrying a magnetic medium such as a magnetic stripe, an optically scanned symbol such as a bar code, or an integrated circuit chip or other memory/data storage device. The illustrated player station 104 also includes a device 309 for receiving value and issuing value in the course of play. This device may accept currency, vouchers, or tokens, for example, and also output currency, vouchers, or tokens. Of course, a separate device may be used to receive and issue value for games played according to the present invention.

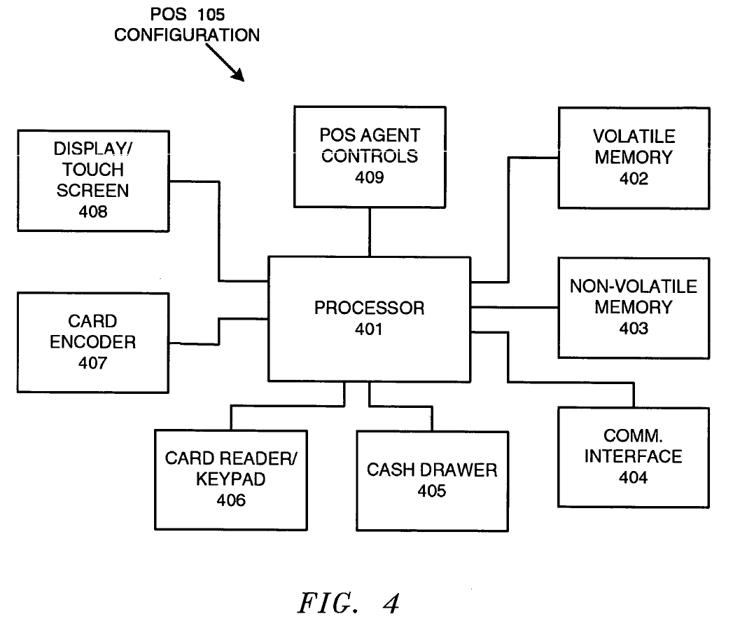

FIG. 4 shows one preferred arrangement for an account assignment/POS station 105 within the scope of the present invention. Account assignment/POS station 105 preferably includes a processor 401, volatile memory 402, nonvolatile memory 403, and a communications interface 404. The volatile and nonvolatile memory store computer program code that may be executed by processor 401 to cause the processor to perform or direct the various functions provided by account assignment/POS station 105. Communications interface 404 allows communications between assignment/POS station 104 and its respective local area system 103 and/or central system 101. Account assignment/POS station 104 shown in FIG. 4 also includes a special user interface arrangement to facilitate an account assignment/POS station operator or agent, and/or a player to interface with the gaming system 100 shown in FIG. 1 for various purposes. This interface includes agent controls 409, a display or touch screen display 408, and a card reader/keypad 406. Controls 409 and display 408 allow a station agent to enter various requests and other information in the gaming system. The nature of these requests or information will depend upon the specific features of the gaming system. For example, controls 409 and display 408 may allow a station agent to enter a request to open a player account in gaming system 100 or a request to withdraw cash from the account where the account maintains cash or credit balances for players in the gaming system. Card reader/keypad 406 comprises a device that can read an external identification device that is carried by a player. In particular card reader/keypad 406 is adapted to read external identifying information for the player from the player's external identification device. A keypad associated with card reader/keypad 406 allows a player to enter a PIN that may be associated with the player account. The illustrated account assignment/POS station 104 further includes a card encoder 407 and a cash drawer 405. Card encoder 407 may be used to produce a player card that may be issued to players who prefer to use a gaming facility-issued identification device or card rather than an external identification device according to the present invention. Cash drawer 405 may be included at account assignment/POS station 104 to facilitate the acceptance of cash to open a cash/credit account for the player or to facilitate payments of cash where the player account system provided through gaming system 100 tracks cash or credit balances for the players.

It will be appreciated that the particular device configurations shown in FIGS. 1 through 4 are shown only for purposes of example. Numerous variations are possible within the scope of the invention. For example, although central system 101 and local area systems 103 are portrayed in FIG. 2 as a single computer system, the functions provided by these gaming system elements may be distributed between several different computer systems in communication with each other. Also, although FIG. 1 in particular suggests a certain physical separation in gaming system function, the functions of the various components shown in FIGS. 1 through 4, may be distributed throughout the system in any suitable fashion consistent with a distributed computing environment that may be employed to implement gaming system 100.

The external identification device reader included with the account assignment/POS stations 105 and the player stations 104 may be adapted to read substantially any type of external identification device, including a mag stripe card, bar coded card, or smart card, or a card or other structure carrying a transceiver adapted to transmit or emit encoded data when energized or activated by a suitable incident signal. Although a single card reader device 308 is shown for player station 104 in FIG. 3 and a single card reader device 406 is shown for account assignment/POS station 105 in FIG. 4, it will be appreciated that the player station and account assignment/POS station may include more than one type of card reader so that the respective station may read identifying information from more than one type of external identification device. Alternatively, a single card reader device 308 and 406 within the scope of the present invention may be adapted to read different types of external identification devices. For example, a single card reader device 308 and 406 within the scope of the present invention may include a magnetic media reading component, and an optical media reading component, and/or a smart card reading component, and/or a transceiver for reading data from a transceiver card or other carrier. It will be appreciated, however, that in a given gaming system, the player station card reader 308 or set of card readers should have the same identification device reading capability as the account assignment/POS station card reader 406 or card reader set. It will also be appreciated that the external identification device readers used in the invention are preferably also adapted to read identifying information from any identification devices that may be issued by the gaming facility.

Some preferred forms of the present invention require a PIN to be used in connection with accessing a player account, at least for certain types of access operations. In these preferred forms of the invention, the card or other identification device readers 308 and 406 at the player stations 104 and account assignment stations 105, respectively, have associated with them a keypad that allows a player to enter their PIN either before or after identifying information is read from the external identification device. Such a keypad may be implemented as a physical keypad included with the external identification device reader or as a keypad displayed on a touch screen display. Preferred forms of the invention provide a PIN keypad through the player station touch screen display (305 in FIG. 3) rather than through a separate physical keypad included at the player station, although separate PIN keypads may be helpful in some applications, such as applications to live card game tables which may include no display at a player station. In any case, where a PIN is required for account access according to the invention, account controller 106 (FIG. 1) also associates the player account for the player with the PIN and stores the association between the player account for the player and the PIN.

A method embodying the principles of the present invention and the operation of the gaming system 100 according to the invention may be described with reference to FIG. 5. It will be appreciated that references to system 100 and system components are references to FIGS. 1 through 4, and that the referenced system components are not shown in FIG. 5.

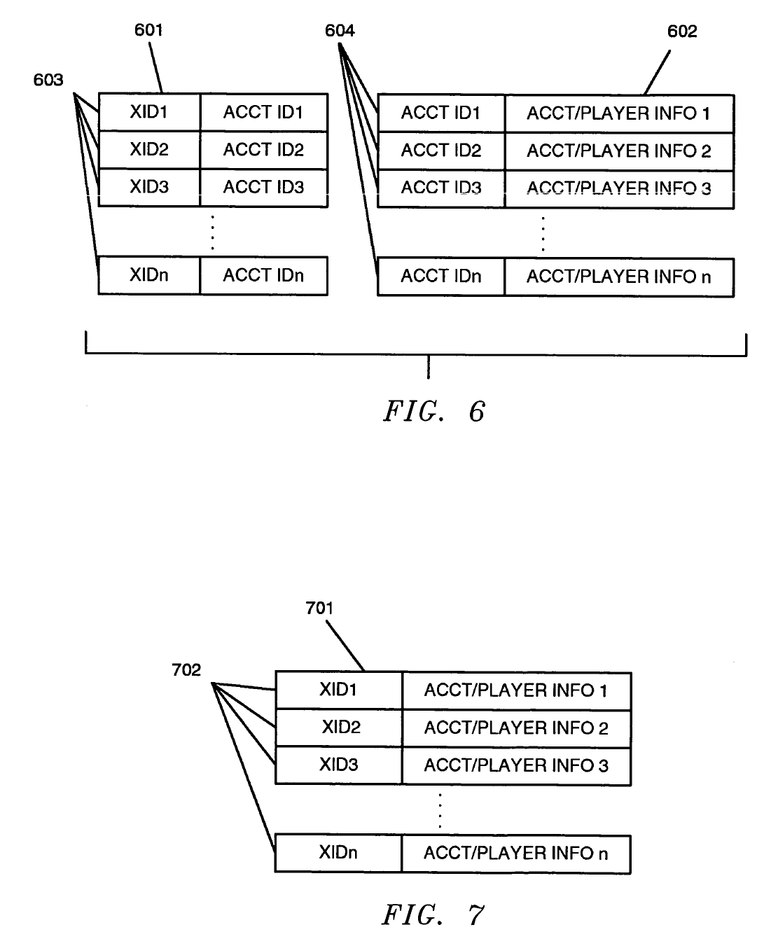

Referring now to FIG. 5, a method embodying the principles of the invention includes the steps of reading external identifying information (XID in the figure) for a player from an external identification device carried by the player as indicated at block 501 and associating the external identifying information with a player account in a gaming system as indicated at process block 502. The association between the external identifying information and player account may be accomplished in a number of different ways within the scope of the invention. FIGS. 6 and 7 describe two alternate methods of association. In any event, the association between the external identifying information and the player account allows information in the player account to be recalled or accessed by the external identifying information. Thus, the invention further includes reading the external identifying information for the player at a player interface such as player station 104 included in the gaming system as indicated at block 510 in FIG. 5, and accessing the player account using the external identifying information read at the player station as indicated at block 514.

In the context of gaming system 100 and gaming system components shown in FIGS. 1 through 4, a player may have their external identification device such as a driver's license, financial institution card, or security card scanned or otherwise read at card reader 406 included at account assignment/POS station 105. The external identifying information read at account assignment/POS station 105 is then communicated or transmitted to the account controller 106, which, in the illustrated system, is associated with the local area system 103 at the gaming facility 102 at which the particular account assignment/POS station 105 is located. Account controller 106 then performs the step shown at block 502 in FIG. 5 and associates the external identifying information with the player account. It will be noted that this initial association between the external identifying information and the player's account may be performed in connection with opening or creating a player account as indicated at 503 in FIG. 5, or in connection with modifying a player account as indicated at block 504 in FIG. 5. With regard to account modification, a player may already have an account established and associated with a gaming facility-issued player card, and the association indicated at blocks 502 and 504 in FIG. 5 may be in connection with modifying the player account to add the association with the external identifying information and thus the external identifying device. This sort of account modification may be made, for example, where a player loses or forgets their gaming facility-issued player card and wishes to use an external identification device to participate in games offered through the gaming system.

Continuing on with the description of the present method in the context of the gaming system and components shown in FIGS. 1 through 4, once the association between the external identifying information and the player account has been made, a player may go to a player interface implemented at player station 104 and have their external identification device scanned or otherwise read by the card reader 308 associated with the player station. The player station 104 then causes the external identifying information read from the external identification device to be communicated or transmitted to the account controller 106. The account controller 106 receiving the external identifying information may then use the external identifying information to access any data stored for the player account as indicated at block 514 in FIG. 5. The process of using the external identifying information to access the player account and player account data and the association between the external identifying information and the player account will be described further below with reference to FIGS. 6 and 7.

It should be noted here that the account access provided through the external identifying information read from the player's external identification device may be for any of a number of different purposes. Player account access may be required in the gaming system in order to allow the player to participate in games offered through the system. Thus, account access gained through the external identifying information may be to play a game as indicated at block 515 in FIG. 5. For example, a player station may allow gaming activity only after being placed in an enabled mode, and access to a player account may be required to place the player station in such an enabled mode. A gaming system may also require player account access in order for the player to modify their account such as by adding funds, withdrawing funds or cashing out completely, or modifying account information. This account modification is indicated at block 516 in FIG. 5. It will be noted that game play using player account access through the external identifying information may be performed at a player station 104 in FIG. 1 as discussed above, and that account modification using player account access through the external identifying information may be performed at an account assignment/POS station 105 in preferred forms of the invention. Thus, the reading step indicated at block 510 in FIG. 5 may be performed through a player interface implemented at an account assignment/POS station 105 in order to obtain the account access indicated at block 514 in FIG. 5.

Preferred forms of the invention requiring a PIN for player account access may include the additional steps indicated in dashed blocks 507, 508, and 511 in FIG. 5. As shown in FIG. 5, the PIN association process may include entering a PIN and then transmitting the PIN to the account controller (106 in FIG. 1) as indicated at dashed block 507. This step may be accomplished through a suitable keypad associated with card reader/keypad 406 at account assignment/POS station 105 (FIG. 4). The PIN transmitted to account controller 106 is then associated with the account in any suitable manner as indicated at dashed block 508 in FIG. 5. Once the association between the PIN and player account is made, the PIN may be required in order to gain access to the player account. Thus, FIG. 5 includes a separate step of entering and transmitting the PIN at block 511 so that the PIN may be used to access the player account.

It will be appreciated that the present invention of associating external identifying information with a gaming system player account for account access is not limited to any particular type of external identifying information. Where PINs are required for account access in combination with external identifying information, the external identifying information need not even be unique to the respective player. External identifying information within the scope of the present invention includes some or all of the data that may be read from a player's external identification device. Some forms of the invention may use only part of the information available on a player's external identification device. For example, a driver's license may carry the driver's name, address, license number, and other information in encoded form, and the present invention may use only the license number or the license number and the state listed in the driver's address as the external identifying information. The present invention may also include truncating or otherwise modifying data from the external identification device for use as the external identifying information according to the present invention. In particular, the present invention may take data from an external identifying device, say a driver's license number, and then use some combining algorithm or technique to combine the driver's license number with data representing the player's name. This process may be used to ensure uniqueness between the external identifying information for the various players in the system. As another example, the present invention may include varying the amount of data used for the player's respective external identifying information as necessary to ensure uniqueness between the identifying information. In any event, the actual data read from a player's external identification device, portions of that data, or modifications of that data, are all considered external identifying information within the scope of the present invention. It will also be appreciated that the truncation or other modification of data read from the external identification device may be performed at any point in the system, at the external device reader, account controller, or any other related component.

FIGS. 6 and 7 may be used to describe two alternate arrangements for associating external identifying information with a player account according to the present invention. The arrangement in FIG. 6 includes two separate data tables, table 601 and table 602. Table 601 comprises a lookup table in which each table entry 603 relates external identifying information (XID) for a given player and account with an account identifier. XID1 in table 601 is associated with a first player, XID2 is associated with a second player, and so forth. Table 602 comprises an account information table in which each entry 604 relates an account identifier with account or player information, which may include pointers to other tables in which account or player information may be stored or collected. It will be appreciated that an implementation of the invention may include multiple tables in the nature of table 602 to store various player or account information. To access a player account using the table arrangement shown in FIG. 6, the invention includes first using the received external identifying information read from a suitable player interface to locate an account identifier, and then using the account identifier to locate player or account information or store additional player or account information.

The arrangement in FIG. 7 includes a single table 701 which directly relates a player's external identifying information with player information and player account information. Each entry 702 in table 701 includes the external identifying information for a respective player and the account or player information for that player. The external identifying information is itself used as an account identifier in the gaming system. In this arrangement shown in FIG. 7, no separate lookup step is required in order to access the player's account using the player's external identifying information.

It will be appreciated that preferred forms of the invention implemented in gaming systems such as system 101 include various data processing devices for performing the functions required in the system. The present invention thus encompasses a program product that includes various operational program code components that are executed by various processing devices to implement the invention. A program product according to the invention includes identifier association program code and account access program code. The identifier association program code is preferably executed at least in part by an account controller, such as account controller 106 in FIG. 1 to receive external identifying information for a player and to associate the external identifying information with a player account in the gaming system. The account access program code is also preferably executed at least in part by an account controller to receive the external identifying information for the player and to access the player's account using the received external identifying information.

It will be appreciated that additional program code will commonly be executed in a gaming system such as system 101 in FIG. 1 to cooperate with the identifier association program code and account access program code. For example, the player stations 104 in FIG. 1 may execute player station program code to prompt the player to present their external identification device and to cause the external identifying information to be transmitted to the account controller 106 when the information is available from the external identification device reader. Account assignment/POS stations 105 may include similar program code which is executed to prompt the player or station agent to present the player's external identification device for reading by the reader associated with the account assignment/POS station, and to then cause the external identifying information to be transmitted to the account controller 106.

A program product according to the present invention may further include PIN association program code for use where account access requires a PIN in addition to the external identifying information. This PIN association program code is preferably executed by an account processing device such as account controller 106 in FIG. 1 to receive a PIN entered by the player, and to associate the PIN with the player account.

The manner in which the identifier association program code and account access program code operate to perform their respective functions will depend heavily upon the manner in with the data is stored in the particular implementation of the invention. In the data table arrangement illustrated in FIG. 7, the identifier association program code assigns the external identifying information as a player account identifier for the player account. The account access program code then applies the external identifying information as an account identifier for the player account in order to access the player account. In contrast, the data table arrangement shown in FIG. 6 requires that the identifier association program code store the external identifying information in a data table entry with an account identifier for the player account. The external identifying information is used to locate the account identifier and the account identifier is used in turn to access the player account.

The above described preferred embodiments are intended to illustrate the principles of the invention, but not to limit the scope of the invention. Various other embodiments and modifications to these preferred embodiments may be made by those skilled in the art without departing from the scope of the present invention.

1. A gaming system including:
(a) an account assignment station including a first external identification device reader, the first external identification device reader being adapted to read external identifying information for a player from an external identification device;
(b) an account controller operatively connected to the account assignment station, the account controller for receiving the external identifying information for the player, for associating a player account for the player with the external identifying information for the player, and for storing the association between the external identifying information for the player and the player account for the player; and
(c) a player interface including a second external identification device reader, the second external identification device reader being adapted to read the external identifying information from the external identification device, and the player interface being a operatively connected to the account controller for communicating the external identifying information to the account controller to facilitate access to the player account for the player.

2. The gaming system of claim 1 wherein the first external identification device reader and the second external identification device reader are each adapted to read identifying information from a magnetic medium included on the external identification device.

3. The gaming system of claim 1 wherein the first external identification device reader and the second external identification device reader are each adapted to read identifying information from a bar code included on the external identification device.

4. The gaming system of claim 1 wherein the first external identification device reader and the second external identification device reader are each adapted to read identifying information from an integrated circuit chip on the external identification device.

5. The gaming system of claim 1 wherein the first external identification device reader and the second external identification device reader are each adapted to read identifying information transmitted from a transceiver on the external identification device.

6. The gaming system of claim 1 wherein the account controller is also for sending account information from the player account to the player station.

7. The gaming system of claim 1 wherein the external identification device comprises a driver's license.

8. The gaming system of claim 1 wherein the external identification device comprises a financial institution card.

9. The gaming system of claim 1 further including:
(a) a first PIN interface included at the account assignment station for receiving a PIN for the player;
(b) a second PIN interface included at the player station for receiving the PIN for the player; and
(c) wherein the account controller is also for associating the player account for the player with the PIN and storing the association between the player account for the player and the PIN.

10. A method including the steps of:
(a) reading external identifying information for a player from an external identification device;
(b) associating the external identifying information with a player account in a gaming system;
(c) after making the association between the external identifying information and the player account, reading the external identifying information for the player at a player interface included in the gaming system; and
(d) accessing the player account using the external identifying information read at the player interface.

11. The method of claim 10 wherein the step of accessing the player account using the identifying information read at the player interface includes locating a database table entry containing the external identifying information, reading a player account identifier from the database table entry, and accessing player account information with the player account identifier.

12. The method of claim 10 further including the step of converting the external identifying information to a modified form and wherein the step of associating the external identifying information with the player account in the gaming system is performed by associating the modified form with the player account.

13. The method of claim 10 wherein the step of associating the external identifying information with the player account in the gaming system comprises assigning the external identifying information as an account identifier in the gaming system.

14. The method of claim 10 wherein the step of accessing the player account requires entry of a PIN.

15. The method of claim 10 further including the step of assigning a PIN to the player and associating the PIN with the player account.

16. A program product stored on a computer readable medium, the program product including:
(a) identifier association program code for receiving external identifying information for a player read from an external identification device, and for associating the external identifying information with a player account in a gaming system;
(b) account access program code for receiving the external identifying information for the player through a player interface included in the gaming system and for accessing the player account using the external identifying information received through the player interface.

17. The program product of claim 16 further including PIN association program code for receiving a PIN entered by the player and associating the PIN with the player account, and wherein the account access program code requires entry of the PIN in order to access the player account.

18. The program product of claim 16 wherein the identifier association program code assigns the external identifying information as an account identifier for the player account.

19. The program product of claim 16 wherein the identifier association program code stores the external identifying information in a data table entry with an account identifier for the player account.

20. The program product of claim 16 wherein the account access program code applies the external identifying information to locate an account identifier for the player account and then applies the account identifier to access information associated with the player account.
